(19) United States
(12) Patent Application Publication
(10) Pub. No.: US 2024/0169280 A1
(43) Pub. Date: May 23, 2024

(54) SYSTEM AND METHOD FOR PROVIDING PROBABILITY OF TIME-OFF GETTING APPROVED

(71) Applicant: NICE LTD., Ra'anana (IL)

(72) Inventor: Richa DEO, Richardson, TX (US)

(21) Appl. No.: 18/057,553

(22) Filed: Nov. 21, 2022

(51) Int. Cl. G06Q 10/0631

(52) U.S. Cl. CPC G06Q 10/06311

(57) ABSTRACT

Workforce management systems and methods, and non-transitory computer readable media, including receiving a time-off request from a first agent, wherein the time-off request comprises an agent ID of the first agent and a first requested date; providing, to a trained machine learning model, staffing data on the first requested date, skills of the first agent, pending time-off requests from other agents on the first requested date, and time-off taken by the first agent in the past; calculating, by the trained machine learning model, an approval probability of the time-off request; and displaying, on a graphical user interface, the approval probability of the time-off request to the first agent and to a manager.

### TECHNICAL FIELD

The present disclosure relates generally to methods and systems of providing approval probability for a time-off request, and more particularly to methods and systems that provide the approval probability for a requested date and may also suggest alternate dates having a higher approval probability.

### BACKGROUND

Methods for forecasting, planning, and analysis for contact processing centers, also known as call centers, are important for increasing the efficiency of contact processing centers. Workforce management (WFM) is an integrated set of processes that a company uses to optimize the productivity of its employees. For example, WFM includes applications that enable contact center management to forecast workloads and align staffing needs around those forecasts. WFM involves effectively forecasting labor requirements and creating and managing staff schedules to accomplish a particular task on a day-to-day and hour-to-hour basis. WFM planning products typically tell a company how much staff they need, i.e., full time equivalent (FTE)/agents.

In a contact center, after an agent submits a time-off request, a manager usually checks net staffing data before approving or declining the request. The agent has to rely on the response from the manager and is not provided probability figures regarding whether his/her time off will be approved or not. Agents do not have an idea upfront about the probability of their time-off requests getting approved or not, and cannot plan their time-off efficiently. The manager has to handle multiple time-off requests coming in by manually checking the staffing requirements at that time and making a decision. Currently, it is believed that approximately 75% of time-off requests are declined. It is a time-consuming activity for a manager to check net staffing requirements and decide to approve or decline time-off requests.

Accordingly, a need exists for improved systems and methods that more efficiently help managers determine whether or not to approve a time-off request, and that help agents determine which days are more likely to be approved.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a system according to embodiments of the present disclosure.

FIG. 2 is a flowchart of a method according to embodiments of the present disclosure.

FIG. 3 illustrates an exemplary method of calculating an approval probability according to embodiments of the present disclosure.

FIG. 4 illustrates a screenshot of a low approval probability for a requested date and higher approval probability for alternate dates according to embodiments of the present disclosure.

FIG. 5 illustrates a screenshot of an agent selecting an alternate date having a higher approval probability according to embodiments of the present disclosure.

FIG. 6 illustrates a screenshot that shows the manager the higher approval probability according to embodiments of the present disclosure.

FIG. 7 illustrates a screenshot with a prompt asking the manager for automatic approval of future time-off requests according to embodiments of the present disclosure.

FIG. 8 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein present the approval probability or the chance of a time-off request being approved when an agent applies for time-off for a specific date or time range (e.g., several days or weeks), and in certain embodiments, also suggests or recommends alternate dates having a higher approval probability. The approval probability is also displayed to managers when they are reviewing the time-off request, which helps them make a more accurate decision.

In one or more embodiments, if a manager shows a pattern of approving time-off requests having a certain or threshold probability, the present system asks the manager if he/she wants to automate the approval of the next time-off request having or exceeding the certain or threshold probability. The certain or threshold probability may be set by the WFM system, the manager, or both.

For example, if the approval probability is greater than or equal to 95%, and the manager is approving this kind of time-off request most of the time, the present system asks the manager if he/she wants to automate the approving process. If he/she checks yes, the present system saves his/her preferences for the approval, and the next time a time-off request with an approval probability of greater than or equal to 95% is submitted, the time-off request is automatically approved without need for manager review.

In various embodiments, the present systems and methods calculate the approval probability by calculating the total net staffing on the requested date. In addition, in some embodiments, a trained machine learning model receives the net staffing conditions, the agent's time-off requests in the past, manager approvals in the past, the skills of the agent, and pending time-off requests of other agents for the requested date, and transforms this data into an approval probability of the time-off request on the requested date. The approval probability is then displayed to both agents and managers. In certain embodiments, alternate days having a higher approval probability are also shown and/or recommended to agents to help agents plan their time-off better, i.e., to have a higher confidence they will receive approval for the requested time off, to adjust their request to increase the likelihood of such approval, or both.

Advantageously, the agent is able to make time-off decisions and plan time-off based on the approval probability more easily. In addition, the agent is able to find alternate days having higher approval probability.

Furthermore, the manager can more confidently make decisions whether to approve or decline time-off requests based on the approval probability. The approval probability helps managers make correct (or at least better) decisions while reviewing time-off requests. Moreover, in several embodiments, the manager can automate approval of time-off requests. If the manager is approving requests with higher approval probability, the present system can prompt if he/she wants to automate this approving process. So, the next time, a time-off request with a higher approval probability can be auto-approved. Overall, the manager saves time and effort.

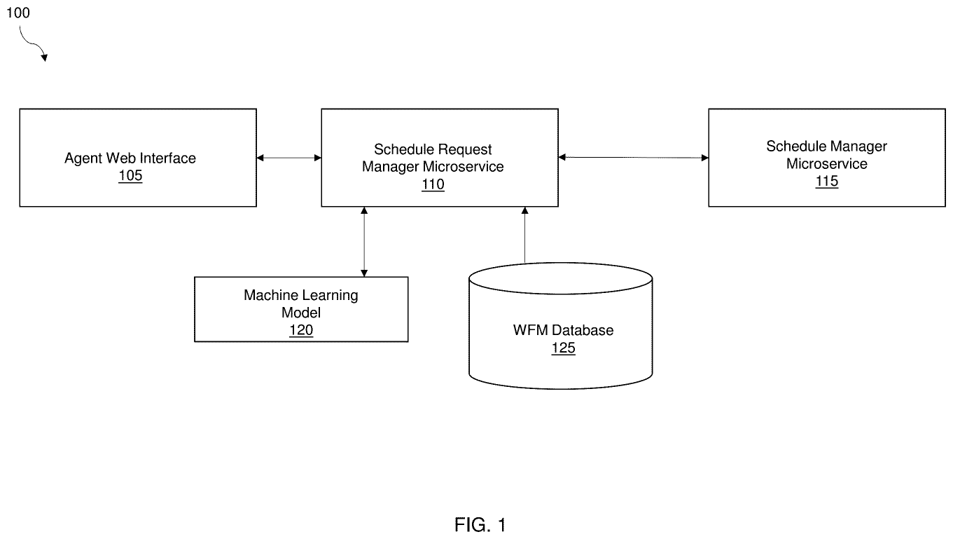

FIG. 1 illustrates a block diagram of a system 100 according to various embodiments of the present disclosure. System 100 includes Agent Web Interface 105, Schedule Request Manager Microservice 110, Schedule Manager Microservice 115, Machine Learning Model 120, and WFM Database 125. An agent submits a time-off request through Agent Web Interface 105, which is the interface for agents. The user ID and the requested date (or range of requested dates) of the time-off request is passed to Schedule Request Manager Microservice 110. Schedule Request Manager Microservice 110 handles all time-off requests coming in from agents. In addition, Schedule Request Manager Microservice 110 handles all scheduling and staffing related functionalities. Schedule Request Manager Microservice 110 requests the net staffing data from Schedule Manager Microservice 115. In response, Schedule Manager Microservice 110 passes the net staffing data to Schedule Request Manager Microservice 110.

Machine Learning Model 120 is trained using data from WFM Database 125. In one embodiment, Machine Learning Model 120 is provided with training data including net staffing data, skills of the agent, overlapping time-off requests from other agents, time-off requests by the agent in the past, and manager approvals (and rejections) of such time-off requests in the past. Machine Learning Model 120 takes these inputs and outputs an approval probability for the time-off request on the requested date or range of requested dates. In one or more embodiments, the present methods include training Machine Learning Model 120.

Once Machine Learning Model 120 is trained, Machine Learning Model 120 can take staffing data on the requested date, skills of the first agent, pending time-off requests from other agents on the requested date, and time-off taken by the first agent in the past from WFM Database 125 and transform this data into an approval probability of the time-off request. In some embodiments, the approval probability is calculated for the requested date and for the next seven (7) days. In various embodiments, the approval probability for the next seven (7) days is shown as the approval probability for alternate days.

In one or more embodiments, Machine Learning Model 120 provides the approval probability to Schedule Request Manager Microservice 110. In certain embodiments, Schedule Request Manager Microservice 110 then returns the approval probability to Agent Web Interface 105, which displays the time-off approval probability along with alternate days to the agent. The agent, by looking at the approval probability figures, is able to make a proper decision when planning his/her time-off. If the approval probability is low, the agent may wish to replan his/her time-off and may choose a date from the suggestion or recommendation of alternate days.

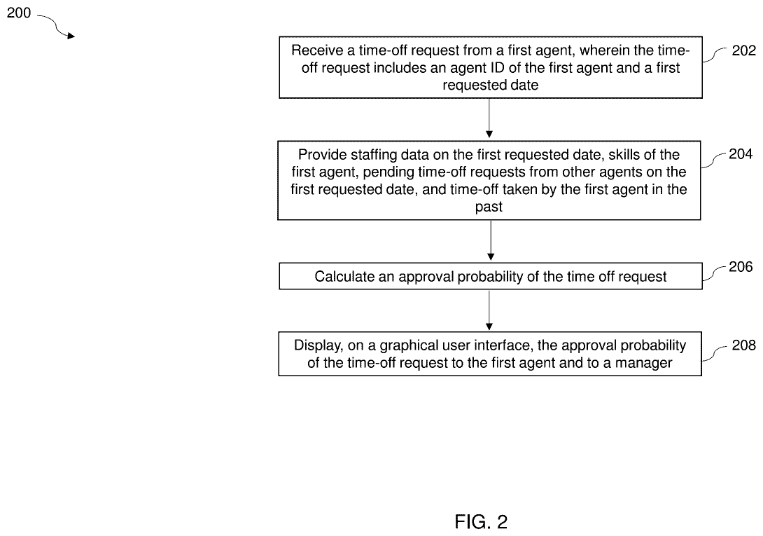

Referring now to FIG. 2, a method 200 according to embodiments of the present disclosure is described. At step 202, Schedule Request Manager Microservice 110 receives a time-off request from a first agent. The time-off request includes an agent ID of the first agent and a first requested date.

At step 204, WFM Database 125 provides staffing data on the first requested date, skills of the first agent, pending time-off requests from other agents on the first requested date, and time-off taken by the first agent in the past to a trained machine learning model, e.g., Machine Learning Model 120.

Staffing data includes the number of required, staffed, and net agents on any given day. The staffing data is generated when schedules are created using forecasting. Staffing data provides figures regarding how many agents are required and the actual number of agents staffed on that date. The net staffing data or percentage is calculated based on the below formula:

Net Staffing Data/Percentage=(staffed−required)/(required*100)

In various embodiments, the trained machine learning model is a tree-based model, although any suitable machine learning model may be used. Examples of tree-based models include, but are not limited to, classification and regression tree (CART), conditional inference trees, and random forests. Tree-based learning models are considered to be one of the best and mostly widely used supervised learning methods. Tree-based models empower predictive models with high accuracy, stability, and ease of interpretation. Tree-based models use a series of if-then rules to generate predictions from one or more decision trees. All tree-based models can be used for either regression (predicting numerical values) or classification (predicting categorical values).

In an exemplary embodiment, the trained machine learning model is a CART model that splits values according to information gain values. CART models construct binary trees using the feature and threshold that yield the largest information gain at each node.

At step 206, trained Machine Learning Model 120 calculates an approval probability of the time-off request for the requested date. In several embodiments, the inputs to trained Machine Learning Model 120 include the staffing condition, skills of the agent, overlapping requests of other agents, agent requests for time-off in the past, and manager approvals (and rejections) of agent time-off requests in the past. Trained Machine Learning Model 120 uses the inputs to compute the time-off approval probability. In an exemplary embodiment, these inputs go through a series of if-then conditions to give an approval probability.

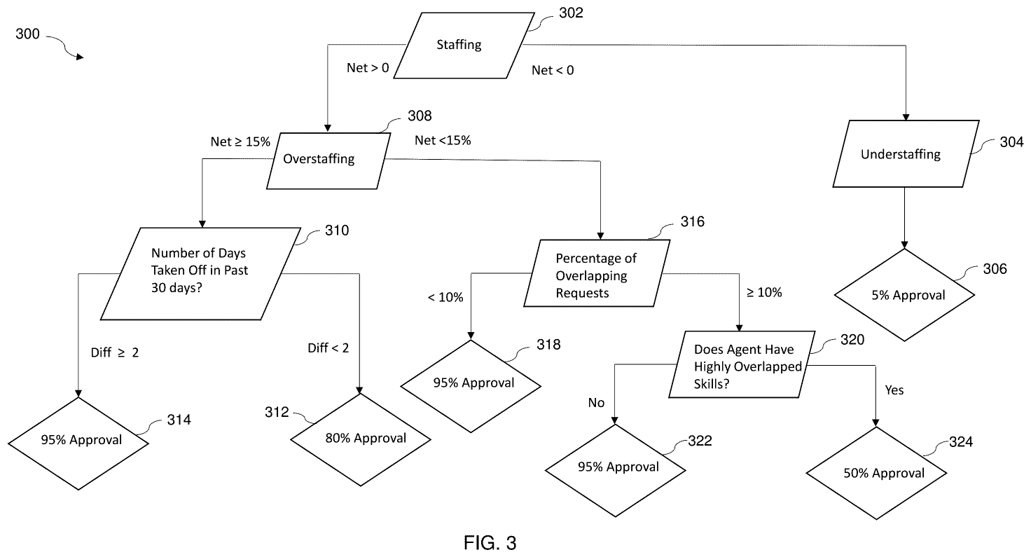

Referring now to FIG. 3, shown is a method 300 detailing how the approval probability is calculated in an exemplary embodiment. In block 302, staffing data is provided as input. The net staffing percentage is calculated as discussed above with respect to step 204 of FIG. 2.

If the value of the net staffing percentage is less than zero (i.e., the number of staffed agents is less than the number of required agents) on the requested date, at block 304, that means there is an understaffing condition. This leads to a low approval probability at block 306 of, for example, 5%, as there are understaffed agents.

If the value of the net staffing percentage is greater than zero (i.e., the number of staffed agents is greater than the number of required agents) on the requested date, at block 308, there is an overstaffing condition. In one embodiment, if the net staffing percentage is greater than or equal to 15%, the past number of days taken off by the agent are considered in block 310. In an exemplary embodiment, the number of days taken off by the agent in the past 30 days are considered.

Initially, a threshold number of time-off requests that an agent is permitted to request in the last 30 days is defined (e.g., by the manager or WFM system), and the number of days the agent has taken off in the past 30 days is then retrieved. The difference is calculated as:

Difference=Threshold−Time-Off Taken

For example, the threshold number of time-off requests (also known as the limit of time-off requests or the limit of days that an agent is permitted to take) may be defined as 5 days. The number of days the agent has actually taken off is 4 days. The difference would be calculated as 5−4=1.

If the difference is less than 2, that means the agent has taken less time-off than the threshold, but the agent has taken time-off close to the defined threshold. There is a smaller probability of the time-off request getting approved. In one embodiment, trained Machine Learning Model 120 returns an approval probability of 80% at block 312.

If the difference is greater than or equal to 2, that means the agent has taken less time-off than the defined threshold, and the agent has not taken time-off close to the defined threshold. There is a larger approval probability. In one embodiment, trained Machine Learning Model 120 returns an approval probability of 95% at block 314.

If the net staffing percentage is less than 15%, method 300 considers the number of overlapping requests of the staffed agents at block 316. If less than 10% of the staffed agents are requesting time-off on the requested date in an overstaffing condition, there is a higher probability of the time-off request getting approved. In one embodiment, trained Machine Learning Model 120 returns an approval probability of 95% at block 318.

If the percentage of overlapping time-off requests is more than or equal to 10%, meaning more agents are requesting time-off on the requested date, the skills of the agent requesting time-off are considered at block 320. For the requested date, agent skills are fetched. If the requestor agent skills are not highly overlapping with the other agents having pending time-off requests on the requested date, the requestor agent's time-off request has a higher probability of getting approved. In one embodiment, trained Machine Learning Model 120 returns an approval probability of 95% at block 322.

In some embodiments, the skills of the requesting agent are mapped to a single skill of the other agents. In other embodiments, the skills of the requesting agent are mapped to multiple skills of other agents. In various embodiments, when 20% of more of the skills of the requestor agent are the same as the other agents, then the skills of the requestor agent are highly overlapping. For example, if at least 30% or 50% of the skills of the requestor agent are the same as the other agents, then the skills of the requestor agent are highly overlapping.

In certain embodiments where the skills of the requestor agent are mapped to multiple skills of other agents, the primary skill (e.g., the predominant skill) of the requesting agent is considered. In other words, the primary skill of the requestor agent is compared with the skills of the other agents to determine if the requestor agent skills are highly overlapping with the skills of other agents.

If the requestor agent skill is highly overlapping with the other agents having pending time-off requests on the requested date, the requestor agent's time-off request has a very low probability of getting approved because the contact center does not want agents having the same skills to take time-off on the same day. In one embodiment, trained Machine Learning Model 120 returns an approval probability of 50% at block 324.

Table 1 provides simulated data for better comprehension of the present methods. For Table 1, data was simulated for different days. The days having a negative net staffing percentage have an understaffing condition so the approval probability is low. The days having a positive net staffing percentage go through the other parameters to determine the approval probability.

TABLE 1
SIMULATED DATA

| | | | | % Net | Staffing | Approval |
|---|---|---|---|---|---|---|
| Date | Required | Staffed | Net | Staffing | Condition | Probability |
| Jul. 14, 2022 | 183 | 80 | −103 | −56.2842 | Understaffing | 5% |
| Jul. 15, 2022 | 183 | 190 | 7 | 3.825137 | Overstaffing | 80% |
| Jul. 16, 2022 | 183 | 200 | 17 | 9.289617 | Overstaffing | 90% |
| Jul. 17, 2022 | 183 | 230 | 47 | 25.68306 | Overstaffing | 95% |
| Jul. 18, 2022 | 183 | 90 | −93 | −50.8197 | Understaffing | 5% |
| Jul. 19, 2022 | 183 | 100 | −83 | −45.3552 | Understaffing | 5% |

For Jul. 14, 2022, the required number of staff is 183 and the number of staffed agents is 80. The net staffing percentage is therefore calculated as (80−183)/183*100=−56.28% Because of the understaffing condition, the approval probability is calculated as 5%.

For Jul. 17, 2022, the required number of staff is 183 and the number of staffed agents is 230. The net staffing percentage is therefore calculated as (230−183)/183*100=25.68%. The net staffing percentage is greater than 15% so trained Machine Learning Model 120 considers the number of days the agent has taken off in the past 30 days.

In some embodiments, the number of days taken off by the agent in the past 30 days are retrieved from WFM Database 125. The defined threshold number of time-off requests or days taken off is also considered. Assume the threshold is defined as 5 days, and the agent has taken 2 days off. The difference is calculated as 5−2=3. The difference is greater than 2, and the approval probability is 95%.

Referring back to FIG. 2, at step 208, Agent Web Interface 105 displays the approval probability of the time-off request to the first agent. The approval probability is also displayed to a manager on a manager web interface.

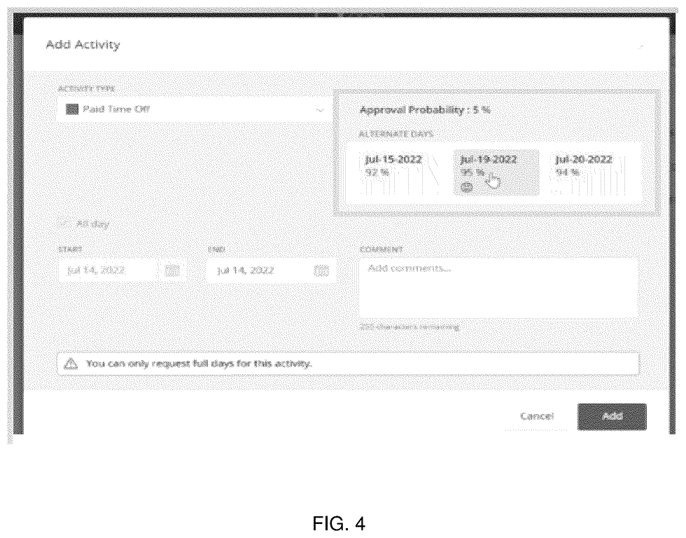

In FIG. 4, illustrated is a screenshot where the approval probability for the requested date of Jul. 14, 2022 is 5% so the agent may wish to choose a date from the alternate days suggested. Here, approval probabilities for Jul. 15, 2022, Jul. 19, 2022, and Jul. 20, 2022 are displayed. Jul. 19, 2022 has the highest approval probability among the list and may be recommended. The agent may replan his schedule and choose Jul. 19, 2022 from the suggestion list.

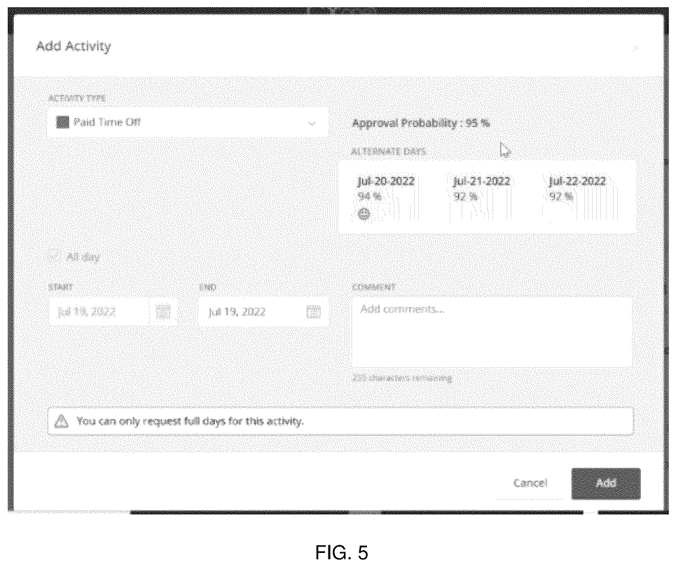

In FIG. 5, the agent selects Jul. 19, 2022, and is navigated to the selected date. The screenshot shows Jul. 19, 2022 has a 95% approval probability, and also provides the approval probabilities for Jul. 20, 2022, Jul. 21, 2022, and Jul. 22, 2022. The agent can request his/her time-off confidently for this date, knowing that it has higher chance of getting approved.

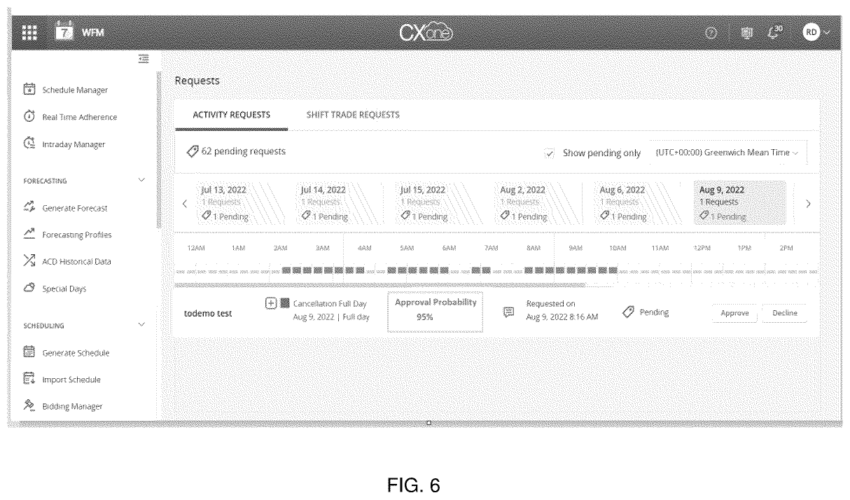

FIG. 6 shows that the agent's time-off request for Jul. 19, 2022 goes to the agent's manager for approval. The time-off approval probability is shown to managers along with the request to help them make the right decision. In the screenshot, the manager can see the approval probability of 95% for the given request, and the manager may go ahead and approve the request. This helps the manager make a correct decision as it is not just net staffing data, but other parameters as well, that must be considered to determine whether to approve or decline the time-off request.

In one or more embodiments, the present system records and saves this approval in WFM Database 125 as part of the manager's approval history. If the manager is approving time-off requests that have an approval probability with 95% and greater most of the time (e.g., more than 10 requests with an approval probability of greater than or equal to 95% were approved by the manager), the present system prompts the manager if he/she wants to automate the process of approving a time-off request next time.

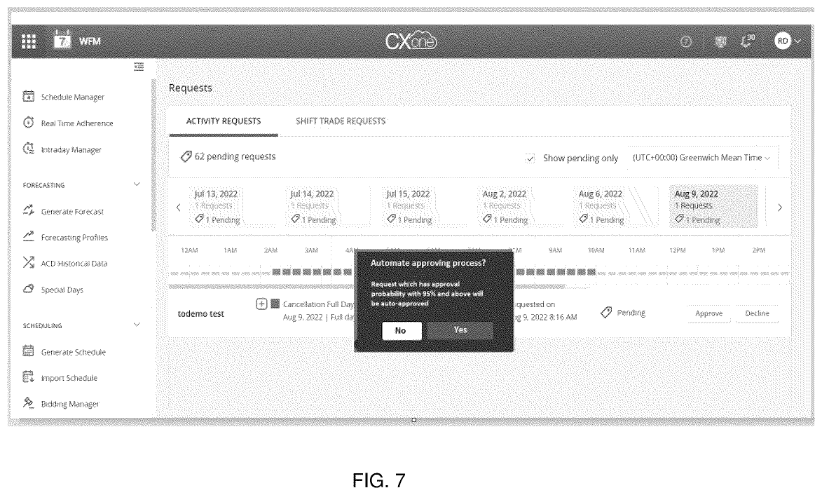

FIG. 7 illustrates a screenshot that displays a prompt asking if the manager wants to automate the approving process for time-off requests having an approval probability 95% or greater. If the manager clicks yes, all future time-off requests with an approval probability of 95% or greater are auto-approved without the manager's manual review and decision-making. This saves time and effort for the manager. If another agent (e.g., a second agent) requests time-off, and the time-off request has an approval probability of 95% or greater, the time-off request is auto-approved. The manager is notified about the auto-approval.

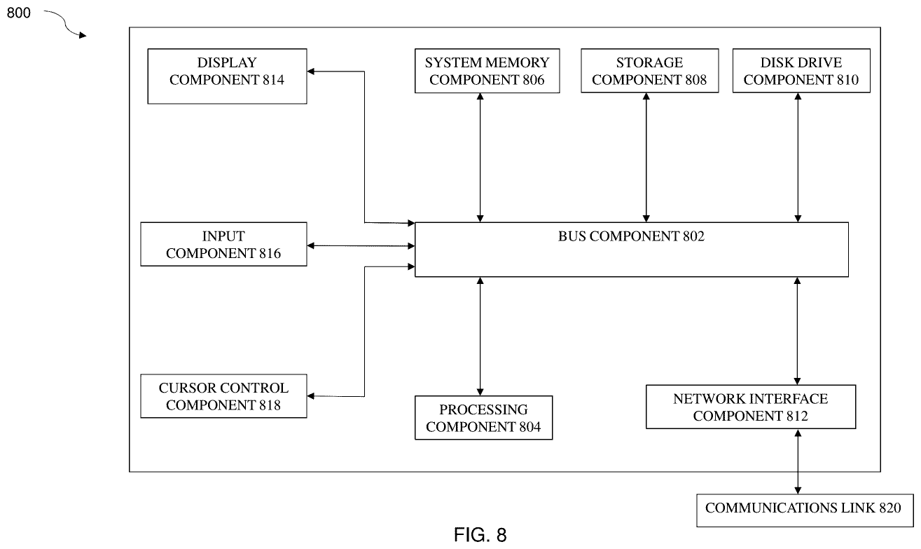

Referring now to FIG. 8, illustrated is a block diagram of a system 800 suitable for implementing embodiments of the present disclosure. System 800, such as part of a computer and/or a network server, includes a bus 802 or other communication mechanism for communicating information, which interconnects subsystems and components, including one or more of a processing component 804 (e.g., processor, micro-controller, digital signal processor (DSP), etc.), a system memory component 806 (e.g., RAM), a static storage component 808 (e.g., ROM), a network interface component 812, a display component 814 (or alternatively, an interface to an external display), an input component 816 (e.g., keypad or keyboard), and a cursor control component 818 (e.g., a mouse pad).

In accordance with embodiments of the present disclosure, system 800 performs specific operations by processor 804 executing one or more sequences of one or more instructions contained in system memory component 806. Such instructions may be read into system memory component 806 from another computer readable medium, such as static storage component 808. These may include instructions to receive a time-off request from a first agent, wherein the time-off request comprises an agent ID of the first agent and a first requested date; provide, to a trained machine learning model, staffing data on the first requested date, skills of the first agent, pending time-off requests from other agents on the first requested date, and time-off taken by the first agent in the past; calculate, by the trained machine learning model, an approval probability of the time-off request; and display, on a graphical user interface, the approval probability of the time-off request to the first agent and to a manager. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 804 for execution. Such a medium may take many forms, including but not limited to, non-volatile media, volatile media, and transmission media. In various implementations, volatile media includes dynamic memory, such as system memory component 806, and transmission media includes coaxial cables, copper wire, and fiber optics, including wires that comprise bus 802. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 800. In various other embodiments, a plurality of systems 800 coupled by communication link 820 (e.g., LAN, WLAN, PTSN, or various other wired or wireless networks) may perform instruction sequences to practice the disclosure in coordination with one another. Computer system 800 may transmit and receive messages, data, information and instructions, including one or more programs (i.e., application code) through communication link 820 and communication interface 812. Received program code may be executed by processor 804 as received and/or stored in disk drive component 810 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A workforce management system comprising:
a processor and a computer readable medium operably coupled thereto, the computer readable medium comprising a plurality of instructions stored in association therewith that are accessible to, and executable by, the processor, to perform operations which comprise:
receiving a time-off request from a first agent, wherein the time-off request comprises an agent ID of the first agent and a first requested date;
providing, to a trained machine learning model, staffing data on the first requested date, skills of the first agent, pending time-off requests from other agents on the first requested date, and time-off taken by the first agent in the past;
calculating, by the trained machine learning model, an approval probability of the time-off request; and
displaying, on a graphical user interface, the approval probability of the time-off request to the first agent and to a manager.

2. The workforce management system of claim 1, wherein the operations further comprise:
providing, to the trained machine learning model, staffing data on alternate dates and pending time-off requests from other agents on the alternate dates;
calculating, by the trained machine learning model, an approval probability of a time-off request of the first agent on the alternate dates; and
displaying, on the graphical user interface, the approval probability of the time-off request on the alternate dates to the first agent and to the manager.

3. The workforce management system of claim 2, wherein the operations further comprise:
receiving, from the first agent, a selection of an alternate date from the alternate dates to take time-off; and
receiving, from the manager, an approval of the alternate date the first agent selected to take time-off.

4. The workforce management system of claim 1, wherein the operations further comprise:
receiving, from the manager, approvals of time-off requests having an approval probability of greater than or equal to a threshold probability;
requesting, from the manager, automatic approval of time-off requests having the approval probability of greater than or equal to the threshold probability; and
receiving, from the manager, confirmation of automatic approval.

5. The workforce management system of claim 4, wherein the operations further comprise:
receiving a time-off request from a second agent, wherein the time-off request comprises an agent ID of the second agent and a second requested date;
providing, to the trained machine learning model, staffing data on the second requested date, skills of the second agent, pending time-off requests from other agents on the second requested date, and time-off taken by the second agent in the past;
calculating, by the trained machine learning model, an approval probability of the time-off request from the second agent, wherein the approval probability is greater than or equal to the threshold probability; and
automatically approving the time-off request from the second agent.

6. The workforce management system of claim 5, wherein the operations further comprise notifying the manager regarding the automatic approval.

7. The workforce management system of claim 1, wherein the trained machine learning model comprises a tree-based model.

8. The workforce management system of claim 7, wherein the tree-based model comprises a classification and regression tree (CART) model.

9. The workforce management system of claim 1, wherein calculating, by the trained machine learning model, an approval probability of the time-off request comprises:
calculating a net staffing percentage on the first requested date based on the staffing data on the first requested date;
defining a threshold number of time-off requests in the past for the first agent;
determining a percentage of staffed agents requesting time-off on the first requested date based on the pending time-off requests from other agents on the first requested date; and
determining whether the skills of the first agent overlap with a plurality of skills of the other agents with pending time-off requests.

10. A method for providing approval probability for a time-off request which comprises:
receiving a time-off request from a first agent, wherein the time-off request comprises an agent ID of the first agent and a first requested date;
providing, to a trained machine learning model, staffing data on the first requested date, skills of the first agent, pending time-off requests from other agents on the first requested date, and time-off taken by the first agent in the past;
calculating, by the trained machine learning model, an approval probability of the time-off request; and
displaying, on a graphical user interface, the approval probability of the time-off request to the first agent and to a manager.

11. The method of claim 10, which further comprises:
providing, to the trained machine learning model, staffing data on alternate dates and pending time-off requests from other agents on the alternate dates;
calculating, by the trained machine learning model, an approval probability of a time-off request of the first agent on the alternate dates; and
displaying, on the graphical user interface, the approval probability of the time-off request on the alternate dates to the first agent and to the manager.

12. The method of claim 11, which further comprises:
receiving, from the first agent, a selection of an alternate date from the alternate dates to take time-off; and
receiving, from the manager, an approval of the alternate date the first agent selected to take time-off.

13. The method of claim 10, which further comprises:
receiving, from the manager, approvals of time-off requests having an approval probability of greater than or equal to a threshold probability;
requesting, from the manager, automatic approval of time-off requests having the approval probability of greater than or equal to the threshold probability; and
receiving, from the manager, confirmation of automatic approval.

14. The method of claim 13, which further comprises:
receiving a time-off request from a second agent, wherein the time-off request comprises an agent ID of the second agent and a second requested date;
providing, to the trained machine learning model, staffing data on the second requested date, skills of the second agent, pending time-off requests from other agents on the second requested date, and time-off taken by the second agent in the past;
calculating, by the trained machine learning model, an approval probability of the time-off request from the second agent, wherein the approval probability is greater than or equal to the threshold probability; and
automatically approving the time-off request from the second agent.

15. The method of claim 10, wherein calculating, by the trained machine learning model, an approval probability of the time-off request comprises:
calculating a net staffing percentage on the first requested date based on the staffing data on the first requested date;
defining a threshold number of time-off requests in the past for the first agent;
determining a percentage of staffed agents requesting time-off on the first requested date based on the pending time-off requests from other agents on the first requested date; and
determining whether the skills of the first agent overlap with skills of the other agents with pending time-off requests.

16. A non-transitory computer-readable medium having stored thereon computer-readable instructions executable by a processor to perform operations which comprise:
receiving a time-off request from a first agent, wherein the time-off request comprises an agent ID of the first agent and a first requested date;
providing, to a trained machine learning model, staffing data on the first requested date, skills of the first agent, pending time-off requests from other agents on the first requested date, and time-off taken by the first agent in the past;
calculating, by the trained machine learning model, an approval probability of the time-off request; and
displaying, on a graphical user interface, the approval probability of the time-off request to the first agent and to a manager.

17. The non-transitory computer-readable medium of claim 16, wherein the operations further comprise:
providing, to the trained machine learning model, staffing data on alternate dates and pending time-off requests from other agents on the alternate dates;
calculating, by the trained machine learning model, an approval probability of a time-off request of the first agent on the alternate dates; and
displaying, on the graphical user interface, the approval probability of the time-off request on the alternate dates to the first agent and to the manager.

18. The non-transitory computer-readable medium of claim 17, wherein the operations further comprise:
receiving, from the first agent, a selection of an alternate date from the alternate dates to take time-off; and
receiving, from the manager, an approval of the alternate date the first agent selected to take time-off.

19. The non-transitory computer-readable medium of claim 16, wherein the operations further comprise:
receiving, from the manager, approvals of time-off requests having an approval probability of greater than or equal to a threshold probability;
requesting, from the manager, automatic approval of time-off requests having the approval probability of greater than or equal to the threshold probability; and
receiving, from the manager, confirmation of automatic approval.

20. The non-transitory computer-readable medium of claim 19, wherein the operations further comprise:
receiving a time-off request from a second agent, wherein the time-off request comprises an agent ID of the second agent and a second requested date;
providing, to the trained machine learning model, staffing data on the second requested date, skills of the second agent, pending time-off requests from other agents on the second requested date, and time-off taken by the second agent in the past;
calculating, by the trained machine learning model, an approval probability of the time-off request from the second agent, wherein the approval probability is greater than or equal to the threshold probability; and
automatically approving the time-off request from the second agent.
